(19) United States
(12) Patent Application Publication
(10) Pub. No.: US 2019/0244751 A1
(43) Pub. Date: Aug. 8, 2019

(54) ELECTROMECHANICAL COMPOSITE COMPONENT AND METHOD FOR PRODUCING SAME

(71) Applicant: MS-SCHRAMBERG HOLDING GMBH & CO. KG, D-78713 SCHRAMBERG (DE)

(72) Inventor: Reinhold BROGHAMMER, Schrarmberg (DE)

(73) Assignee: MS-SCHRAMBERG HOLDING GMBH & CO. KG, D-78713 SCHRAMBERG (DE)

(21) Appl. No.: 16/318,641

(22) PCT Filed: Sep. 5, 2017
(86) PCT No.: PCT/EP2017/072192

§ 371 Date: Jan. 17, 2019

(30) Foreign Application Priority Data
Sep. 20, 2016 (DE) 20 2016 105 237.8

(51) Int. Cl. H01F 41/02; H01F 7/02; H02K 1/27; B22F 7/08

(52) U.S. Cl. CPC H01F 41/0266; H01F 7/0221; H02K 15/03; B22F 7/08; H02K 1/2726

(57) ABSTRACT

An electromechanical composite component having a sleeve and a magnet device positioned therein, which is compressed out of a powdered material containing magnetic particles, and at least one cover, which closes the sleeve in a sealed fashion at the end. The magnet device is affixed in the sleeve in a frictionally engaging way in that a molded body, which is compressed out of the magnetic material, is inserted into the sleeve with sliding friction and produces a frictionally engaging press-fitted connection in the sleeve as it relaxes.

### BACKGROUND OF THE INVENTION

### Field of the Invention

This invention relates to an electromechanical composite component having a sleeve and a magnet device positioned therein, which is compressed out of a powdered material containing magnetic particles, and at least one cover, which closes the sleeve in a sealed fashion at the end, and also relates to a method for producing such a composite component.

### Discussion of Related Art

An electromechanical composite component of this kind, specifically in the form of a rotor for an electric motor, is disclosed in German Patent Reference DE 20 2008 017 587 U1. In this known rotor, a sintered permanent magnet is inserted into an encapsulation, which has a cylindrical casing section in the form of a sleeve and has end parts that are mounted onto the end of it in a sealed way. The permanent magnet is mounted on a shaft, which is routed in a sealed manner through shaft feedthroughs of the end parts. All of the transitions between the casing section and the end parts are closed in a sealed fashion, for example welded, soldered, or crimped and/or provided with a jointing compound, such as paste or glue.

PCT Patent Reference WO 2013/110755 A1 discloses a method for lining the inner surface of a hollow body in the form of a sleeve with a pressed magnetic molded body of powdered material having a bonding agent and a correspondingly produced functional part. A special feature of this method includes that the pressed molded body is affixed in the hollow body in a frictionally engaging way without further accessories and process steps, such as gluing or thermal fixing in the sleeve-shaped hollow body, by its relaxation after the pressing procedure and insertion procedure.

Other composite components, in particular rotors, with a permanent magnet positioned inside a cylindrical encapsulation are disclosed in German Patent Reference DE 196 17 134 A1, European Patent Reference EP 0 243 187 A2, U.S. Pat. No. 3,968,390 A, German Patent Reference DE 103 14 394 B4, and German Patent Reference DE 11 2006 002 084 T5. Various embodiments are disclosed in these documents.

In a method described in PCT Patent Reference WO 2011/126026 A1, a bonded magnet is immobilized in a hollow body by a thermal treatment, requiring steps that are tailored to the thermal procedures.

### SUMMARY OF THE INVENTION

One object of this invention is to provide an electromechanical composite component, such as a rotor for an electric machine, whose design makes it possible to provide various embodiments at the lowest possible cost while achieving a reliable functionality.

This object is attained with features described in this specification and in the claims. In some embodiments of this invention, the magnet device is affixed in the sleeve in a frictionally engaging way with a molded body, which is compressed from the magnetic material, is inserted into the sleeve with sliding friction and produces a press-fitted connection in the sleeve as it relaxes.

The composite component that is produced in this way forms a compact unit with a permanent magnet or magnet device that is inserted in a frictionally engaging way, without glue or thermal fixing procedures, and affixed in the sleeve. Extensive investigations and testing by the inventors have shown that the composite component durably satisfies high functional requirements, even under adverse usage conditions. With the sealed closure with the end covers, the permanent magnet is also accommodated so that it is protected from aggressive environments, such as liquid or gas. Because the magnet body is inserted directly into the sleeve, it is already possible during the manufacturing phase to achieve a precise matching of the encapsulation to the sleeve and covers and possibly of an inserted axle or shaft in connection with the magnet body or magnet device, which makes it possible to avoid performing a balancing procedure and to achieve an exact concentricity. The production method by inserting the magnet device and affixing it in a frictionally engaging way without glue or thermal fixing also makes it possible to achieve a thin-walled magnet geometry and also a very thin sleeve wall thicknesses of, for example, less than 0.5 mm and even less than 0.2 mm. It is also possible to use different magnet materials, such as isotropic or anisotropic NdFeB magnet materials, for the manufacture. It is possible to use metallic or ceramic materials for the axle if it is used. The above-mentioned design advantageously permits a precisely controllable or regulatable production and through the direct insertion of the molded body into the sleeve, achieves a production method that can be precisely tailored to the desired properties of the finished composite component while maintaining very strict tolerances because an additional glue layer is not introduced for the production, such as conventional glue-in techniques, and no additional steps have to be carried out, such as the heating of a molded body and insertion of the heated molded body.

Other advantageous sample embodiments are disclosed in this specification and in the claims.

One advantageous embodiment for a precise production and function includes the fact that the wall thickness of the sleeve is at most 0.5 mm, in particular at most 0.2 mm.

Another advantageous embodiment for particular applications include the fact that an axle that extends through the at least one cover is guided concentrically by the sleeve and the magnet device.

A contribution to a durably favorable function, even in a chemically or physically adverse environment, can be made if the at least one cover is affixed to the associated end of the sleeve in a fluid-tight fashion and the possibly provided axle and is affixed to the sleeve by flanging, crimping or beading.

Advantageous steps for the production and function include the fact that the at least one cover is welded to the associated end of the sleeve and possibly the axle in a fluid-tight fashion, in particular by laser welding, and also in the fact that the at least one cover is fixed in position by being injection molded or extrusion coated onto the sleeve and possibly the axle.

Other advantageous embodiments of this invention include the fact that the sleeve is of metal or plastic, in particular glass fiber-reinforced plastic or a carbon fiber-reinforced plastic.

For different applications, it is also possible for the axle to be of or composed of metal or ceramic.

Embodiments of this invention that are advantageous for different applications also result from the magnet device having a cylindrical magnet body with a solid or annular cross-section.

Other advantageous embodiments are achieved if a filler body is inserted concentrically into the magnet body.

### BRIEF DESCRIPTION OF THE DRAWINGS

This invention is explained in greater detail in view of exemplary embodiments with reference to the drawings, wherein:

FIG. 1A shows a first exemplary embodiment of an electromechanical composite component, for example, for a rotor of an electric machine, with a magnet device in the form of a thin-walled permanent magnet inserted into a sleeve, in a perspective view that is open at one end;

FIG. 1B shows a perspective view of another embodiment of a composite component with a magnet device inserted into a thin-walled sleeve and a central axle;

FIG. 2A shows a perspective view of another embodiment of a composite component with a magnet device inserted into a thin-walled sleeve, end covers, and a central axle;

FIG. 2B shows a perspective view of another embodiment of a composite component with a magnet device inserted into a thin-walled sleeve, end covers, and a central axle; and

FIG. 3 shows a composite component in a disassembled state.

### DETAILED DESCRIPTION OF THE INVENTION

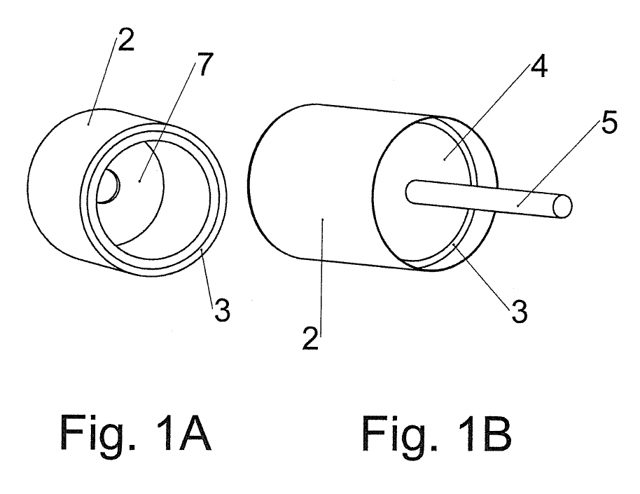

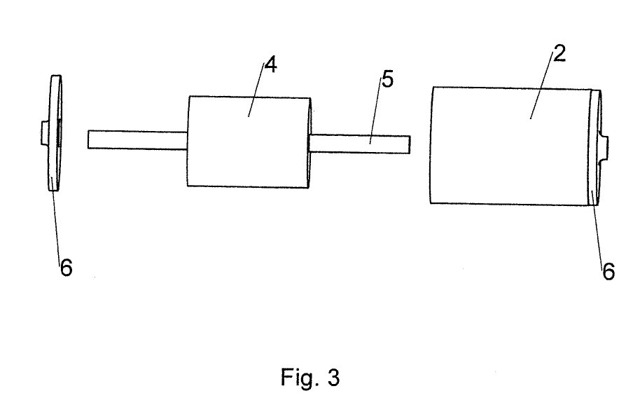

FIG. 1A shows a composite component 1 with a cylindrical sleeve 2, into which a magnet body 3 of a magnet device is inserted and which is closed at its one end, the rear end in the figure, with a cover, in the form of a bottom 7 in this case, and is open at its other end, the front end in this case. The bottom 7 has a central through opening concentric to the sleeve 2 for an axle 5 such as a shaft of the kind that is used, for example, for the construction of a rotor of an electric machine. The bottom 7 can be formed onto the sleeve 2 of one piece with it or can be placed onto it as a separate component in the form of a cover 6, as shown in FIG. 3, and be mounted onto the relevant terminal edge of the sleeve 2 in a sealed fashion. Correspondingly, the front end is also provided with or has a cover 6, which is mounted onto the relevant terminal edge of the sleeve 2 in a sealed fashion. If an optional axle 5 is used, then a sealed connection is also produced between the bottom 7 or the cover 6 and the optional axle 5, so that for example when used in a liquid, this liquid does not penetrate into the interior of the sleeve 2 where it could damage the magnet body 3.

The magnet body 3 is inserted into the sleeve 2 by being inserted using the method that is described in detail in PCT Patent Reference WO 2013/110755 A1 mentioned at the beginning, and has or includes a pressed molded body made of powdered material with magnetic particles distributed in it. The molded body that is pressed in a female die is inserted into the sleeve with an exact fit with sliding friction and after being positioned on the inside of the sleeve 2, becomes pressed firmly into place in a frictionally engaging way against the inner surface thereof as it relaxes, without requiring the use of an additional glue layer. The frictionally engaging press-fitted connection also does not require any heating. The pressed molded body in this case can have an annular or solid, for example circular, cross-section and its outer circumference is matched to the inner circumference of the sleeve 2. If the cross-section of the molded body is annular, then a filling body or inner body 4 can be fitted into its interior, such as shown in FIG. 3.

The pressed molded body is axially compressed, for example by a factor of 2 to 3, relative to its loose filling state in the female die. The factor or compressing pressure is chosen as a function of the material composition and can also be above this range. Because of the compressed density, the molded body relaxes or breathes in the sleeve 2 after the removal of the press tool or tools and is then affixed with a powerful holding force directly against the inner surface of the sleeve 2. In addition, the inner surface of the sleeve 2 can be provided with or have gripping structures for producing a fixing or catching action.

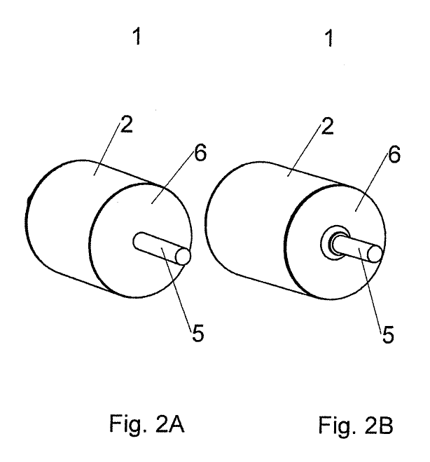

The composite component 1 that is formed in this way by the fixing of the molded of or body composed of the magnetic material in the sleeve 2 is closed in a sealed fashion by the end covers 6 or by a cover 6 and the bottom 7, as demonstrated by the exemplary embodiment shown in FIGS. 2A and 2B. For example, the cover or covers 6 according to FIG. 2A can be injection molded in a sealed fashion onto the sleeve 2 that is provided with the magnet body 3 or magnet device or can be welded at the circumference to the relevant terminal edges of the sleeve 2.

An advantageous connecting method is also a flanging between the edge region of the cover 6 or covers 6 and the terminal edge regions of the sleeve 2. Thus, edge regions of the sleeve 2 and cover 6 that extend axially alongside each other are bent over together or one is bent over the other by 180° one time or multiple times, possibly with the interposition of a sealing compound.

As FIG. 1B shows, the magnet body 3, if it is embodied as annular in cross-section, can have an inner body 4 inserted into it already during the production of the pressed molded body in the female die or subsequently after the insertion of the molded body into the sleeve 2. The inner body 4 can be placed separately onto the optional axle 5 and fastened to it or can be embodied of one piece or integrally to it, as is also shown in FIG. 3.

The optional axle 5 or shaft can correspondingly be already used in the production of the pressed molded body in the female die or subsequently, after the insertion of the molded body into the sleeve 2.

The wall of the sleeve 2 preferably is of or consists of nonmagnetic or non-magnetizable material, it being possible to use a nonmagnetic or non-magnetizable material such as GFK or CFK.

With the thin-walled embodiment of the sleeve 2, it is possible during the joining process, in particular during the relaxing of the molded body as it expands or breathes, a certain expandability of the wall can also be used, which then, thanks to an inwardly directed exertion of elastic forces, promotes the frictionally engaging connection and the compact design of the composite component.

1. An electromechanical composite component (1) having a sleeve (2) and a magnet device positioned therein, which is compressed out of a powdered material containing magnetic particles, and at least one cover (6), which closes the sleeve (2) in a sealed fashion at the end, the composite component comprising:
the magnet device is affixed in the sleeve (2) in a frictionally engaging way with a molded body compressed out of the magnetic material and inserted into the sleeve (2) with sliding friction and producing a frictionally engaging press-fitted connection in the sleeve (2) as it relaxes.

2. The composite component according to claim 1, wherein
the wall thickness of the sleeve (2) is at most 0.5 mm, in particular at most 0.2 mm.

3. The composite component according to claim 2, wherein
an optional axle (5) that extends through the at least one cover (6) is guided concentrically by the sleeve (2) and the magnet device.

4. The composite component according to claim 3, wherein
the at least one cover (6) is affixed to an associated end of the sleeve (2) in a fluid-tight fashion and the optional axle (5) and is affixed to the sleeve (2) by flanging.

5. The composite component according to claim 4, wherein
the at least one cover (6) is welded to the associated end of the sleeve (2) and the optional axle (5) in a fluid-tight fashion by laser welding.

6. The composite part according to claim 5, wherein
the at least one cover (6) is fixed in position by being injection molded or extrusion coated onto the sleeve (2) and the optional axle (5).

7. The composite component according to claim 6, wherein
the sleeve (2) is of a metal or a plastic material, in particular glass fiber-reinforced plastic or a carbon fiber-reinforced plastic.

8. The composite component according to claim 7, wherein
the optional axle (5) is of a metal or a ceramic material.

9. The composite component according to claim 8, wherein
the magnet device has a cylindrical magnet body (3) with a solid cross-section or annular cross-section.

10. The composite component according to claim 8, wherein
a filler body is inserted concentrically into the magnet body (3).

11. A method for producing a composite component (1) having a sleeve (2) and a magnet device positioned therein, in which a molded body is compressed out of a powdered material containing magnetic particles and after insertion of the molded body, the sleeve (2) is closed in a sealed fashion on at least one end, the method including inserting
the compressed molded body into the sleeve (2) with sliding friction and when relaxed becomes fixed in position in a frictionally engaging way, producing a press-fitted connection in the sleeve (2).

12. The composite component according to claim 1, wherein an optional axle (5) that extends through the at least one cover (6) is guided concentrically by the sleeve (2) and the magnet device.

13. The composite component according to claim 1, wherein the at least one cover (6) is affixed to an associated end of the sleeve (2) in a fluid-tight fashion and the optional axle (5) and is affixed to the sleeve (2) by flanging.

14. The composite component according to claim 1, wherein the at least one cover (6) is welded to the associated end of the sleeve (2) and the optional axle (5) in a fluid-tight fashion by laser welding.

15. The composite part according to claim 1, wherein the at least one cover (6) is fixed in position by being injection molded or extrusion coated onto the sleeve (2) and the optional axle (5).

16. The composite component according to claim 1, wherein the sleeve (2) is of a metal or a plastic material, in particular glass fiber-reinforced plastic or a carbon fiber-reinforced plastic.

17. The composite component according to claim 2, wherein the optional axle (5) is of a metal or a ceramic material.

18. The composite component according to claim 1, wherein the magnet device has a cylindrical magnet body (3) with a solid cross-section or an annular cross-section.

19. The composite component according to claim 17, wherein a filler body is inserted concentrically into the magnet body (3).
